(19) United States
(12) Patent Application Publication
(10) Pub. No.: US 2005/0128025 A1
(43) Pub. Date: Jun. 16, 2005

(54) Ultralow temperature low noise amplification apparatus

(75) Inventors: Takashi Uchida, Tokyo (JP); Masaki Suto, Tokyo (JP); Noriyuki Kagaya, Tokyo (JP)

Correspondence Address: MCGINN & GIBB, PLLC, 8321 OLD COURTHOUSE ROAD, SUITE 200, VIENNA, VA, 22182-3817, US

(73) Assignee: Hitachi Kokusai Electric Inc., Tokyo (JP)

(21) Appl. No.: 10/968,349

(22) Filed: Oct. 20, 2004

(30) Foreign Application Priority Data
Oct. 23, 2003 (JP) 2003-362902

(51) Int. Cl. H01P 1/00; H01B 12/02

(52) U.S. Cl. 333/99 S; 505/210

(57) ABSTRACT

An ultralow-temperature low-noise amplification apparatus of high sensitivity which realizes a small size, a light weight, a low electric power consumption and a low price. As the insertion loss caused by high-frequency cables and a superconducting filter installed as a first signal transmitting device before a first-stage amplifier is most responsible for any increase in the noise figure of the ultralow-temperature low-noise amplification apparatus as a whole, they are formed from a material causing only a small insertion loss to reduce the noise figure of the apparatus effectively. A high-frequency cable forming a third signal transmitting device not affecting the noise figure of the apparatus substantially is formed from a material of low thermal conductivity, so that it is possible to prevent any external heat from entering a heat-insulating container through an output connector to hold the interior of the container steadily at a low temperature and thereby keep the noise figure of the apparatus at a low level.

### BACKGROUND OF THE INVENTION

1. Field of the Invention

This invention relates to an ultralow-temperature low-noise amplification apparatus having a first-stage amplifier and a final-stage amplifier cooled to a very low temperature between an input connector and an output connector.

2. Description of the Related Art

FIG. 6 is a block diagram showing in a simplified form the layout of a known highly sensitive amplification apparatus used in e.g., a wireless communication system. In the highly sensitive amplification apparatus 61, input signals applied to an input connector 131 are amplified by a first-stage amplifier 111 and delivered to a final-stage amplifier 121. The amplified signals received by the final-stage amplifier 121 are further amplified and outputted through an output connector 141. Power is supplied to the first- and final-stage amplifiers 111 and 121 through a power supply connector 151. If an amplifying element having a low noise figure is selected as a principal component of each of the first- and final stage amplifiers 111 and 121, it is possible to improve the noise figure of each amplifier and thereby the high sensitivity of the highly sensitive amplification apparatus as a whole.

The noise figure is an important factor for the evaluation of a highly sensitive amplification apparatus and is desirably as small as possible, and a HEMT (high electron mobility transistor) is, for example, used as a low-noise amplifying element for the microwave frequency range. Even if a low-noise amplifying element, such as a HEMT, may be used, however, its noise figure depends on the frequency range of the input signals to be amplified, and a problem in which no desired noise figure cannot be obtained would be raised, depending on their frequency range. On the other hand, it is known that an amplifying element generally has a smaller noise figure when used at a low temperature than at a high temperature. Therefore, there has already been proposed a cooled highly sensitive amplification apparatus in which an amplifying element is cooled to realize a noise figure suited for a highly sensitive amplification apparatus.

FIG. 7 is a block diagram showing in a simplified form the layout of a known low-temperature low-noise amplification apparatus comprising a cooled highly sensitive amplification apparatus as mentioned above. In the low-temperature low-noise amplification apparatus 62, amplifiers 111 and 121 supplied with power from a power supply connector 151 amplify input signals applied to an input connector 131 and send amplified signals to an output connector 141. Accordingly, its function is equal to that of the highly sensitive amplification apparatus 61 shown in FIG. 6. The apparatus shown in FIG. 7, however, includes a low temperature holder 172 cooled by a freezer 173 and positioned in contact with the amplifiers 111 and 121. The amplifiers 111 and 121, the low temperature holder 172 and those parts of the connectors 131, 141 and 151 which face the amplifiers are held in a tightly closed heat-insulating container 171, its interior of which is maintained vacuum by an evacuator not shown. Therefore, the interior of the heat-insulating container 171 including the low temperature holder 172 is steadily kept at a low temperature.

Although in the apparatus described above, it is only the amplifiers that are installed inside for signal processing, a highly sensitive amplification apparatus for processing high-frequency signals sometimes has a receive filter formed from a high-temperature superconductor. A high-temperature superconductor, such as an oxide superconductor, exhibits superconductivity at or below a critical temperature of about 70 K. If a receive filter formed from such a superconductor is combined with a low-temperature low-noise amplification apparatus and if all the necessary parts including the receive filter are kept at or below the critical temperature, it is possible to realize a great reduction of any loss caused by the receive filter, etc. and thereby a drastic improvement in the noise figure of the apparatus as a whole.

FIG. 8 is a block diagram showing a known ultralow-temperature low-noise amplification apparatus made by combining a low-temperature low-noise amplification apparatus and a receive filter formed from a high-temperature superconductor as stated above. The ultralow-temperature low-noise amplification apparatus 63 is made by interposing a superconducting filter 110 between the first-stage amplifier 111 and input connector 131 in the low-temperature low-noise amplification apparatus 62 shown in FIG. 7. The superconducting filter 110, as well as the first- and final-stage amplifiers 111 and 121, is positioned in contact with a low temperature holder 172 and cooled to a predetermined temperature equal to or below the critical temperature.

In the apparatus shown in FIG. 8, high-frequency signals applied to the input connector 131 pass through a high-frequency cable 132, and the signals in a pass band of frequencies are allowed to pass through the superconducting filter 110 and pass through a high-frequency cable 133 to the first-stage amplifier 111 whereby they are amplified. The high-frequency signals amplified by the first-stage amplifier 111 pass through a high-frequency cable 143 and are amplified by the final-stage amplifier 121 and the amplified signals pass through a high-frequency cable 142 and are outputted through an output connector 141. Accordingly, the radio amplification apparatus 63 shown in FIG. 8 is substantially the same in performance as the low-temperature low-noise amplification apparatus 62 shown in FIG. 7, except that the inputted high-frequency signals are filtered by the superconducting filter 110.

For the proper operation of the radio amplification apparatus 63 shown in FIG. 8, it is necessary to have the freezer 173 cool and hold various parts of the ultralow-temperature low-noise amplification apparatus 63 steadily at or below the critical temperature and it is, therefore, important to keep the freezer 173 reliable in performance. An increase in the amount of heat entering the heat-insulating container 171 calls for a higher freezing power and results in a cost increase caused by the necessity for a larger and heavier freezer and a greater electric power consumption.

### SUMMARY OF THE INVENTION

Under these circumstances, it is an object of this invention to provide an ultralow-temperature low-noise amplification apparatus of high sensitivity which realizes a small size, a light weight, a low electric power consumption and a low price.

According to one aspect of this invention, the above object is attained by an ultralow-temperature low-noise amplification apparatus having a first-stage amplifier and a final-stage amplifier which are cooled to a very low temperature between an input connector and an output connector, the apparatus further comprising an input connecting device connecting the input connector and the first-stage amplifier and so arranged as to reduce any insertion loss and an output connecting device connecting the final-stage amplifier and the output connector and so arranged as to reduce the conduction of heat.

According to another aspect of this invention, there is provided an ultralow-temperature low-noise amplification apparatus comprising a first signal transmitting device connecting an input connector and a receive filter, a second signal transmitting device connecting the receive filter and a first-stage amplifier, a third signal transmitting device connecting the first-stage amplifier and a final-stage amplifier, a fourth signal transmitting device connecting the final-stage amplifier and an output connector, a cooling holder for cooling the receive filter, second signal transmitting device, first-stage amplifier, third signal transmitting device and final-stage amplifier to a very low temperature and holding them at that temperature, and a heat-insulating container carrying the input and output connectors and a power supply connector on its outer wall and enclosing the second signal transmitting device, first-stage amplifier, third signal transmitting device, final-stage amplifier and cooling holder tightly in a vacuum state.

The first signal transmitting device is preferably of a material of low resistivity.

The receive filter, second and third signal transmitting devices, and final-stage amplifier preferably constitute a single module.

According to still another aspect of this invention, there is provided an ultralow-temperature low-noise amplification apparatus comprising a receive filter connected to an input connector, a first signal transmitting device connecting the receive filter and a first-stage amplifier, a second signal transmitting device connecting the first-stage amplifier and a final-stage amplifier, a third signal transmitting device connecting the final-stage amplifier and an output connector, a cooling holder for cooling the receive filter, first signal transmitting device, first-stage amplifier, second signal transmitting device and final-stage amplifier to a very low temperature and holding them at that temperature, and a heat-insulating container carrying the input and output connectors and a power supply connector on its outer wall and enclosing the receive filter, first signal transmitting device, first-stage amplifier, second signal transmitting device, final-stage amplifier and cooling holder tightly in a vacuum state.

The receive filter, first and second signal transmitting devices, and final-stage amplifier preferably constitute a single module.

The insertion loss caused by the first signal transmitting device positioned before the first-stage amplifier is the most responsible for any increase in the noise figure of the ultralow-temperature low-noise amplification apparatus as a whole. Therefore, the first signal transmitting device is formed from a material causing only a small insertion loss to reduce the noise figure of the whole apparatus effectively. The third signal transmitting device not substantially affecting the noise figure of the apparatus is formed from a material of low thermal conductivity, so that it may be possible to prevent any external heat from entering the heat-insulating container through the output connector, keep the interior of the heat-insulating container steadily at a low temperature and thereby maintain a low noise figure for the apparatus.

According to the present invention, the use of adequate materials for the first signal transmitting device on the input side of the apparatus and the third signal transmitting device on the output side as stated above makes it possible to provide an ultralow-temperature and low-noise amplification apparatus of high sensitivity which has an improved noise figure, does not call for any cooling device having a very high cooling capacity, but realizes a small size, a light weight, a low electric power consumption and a low price.

### BRIEF DESCRIPTION OF THE DRAWINGS

FIG. 1 is a block diagram for explaining the principle of this invention;

FIG. 2 is another block diagram for explaining the principle of this invention;

FIG. 3 is a block diagram showing a first form of ultralow-temperature low-noise amplification apparatus embodying this invention;

FIG. 4 is a block diagram showing a second form of ultralow-temperature low-noise amplification apparatus embodying this invention;

FIG. 5 is a block diagram showing a third form of ultralow-temperature low-noise amplification apparatus embodying this invention;

FIG. 6 is a block diagram showing in a simplified form the layout of a known highly sensitive amplification apparatus used in e.g., a wireless communication system;

FIG. 7 is a block diagram showing in a simplified form the layout of a known low-temperature low-noise amplification apparatus constituted by a cooled highly sensitive amplification apparatus; and

FIG. 8 is a block diagram showing a known ultralow-temperature low-noise amplification apparatus made by combining the low-temperature low-noise amplification apparatus shown in FIG. 7 and a receive filter formed from a high-temperature superconductor.

### DETAILED DESCRIPTION OF THE INVENTION

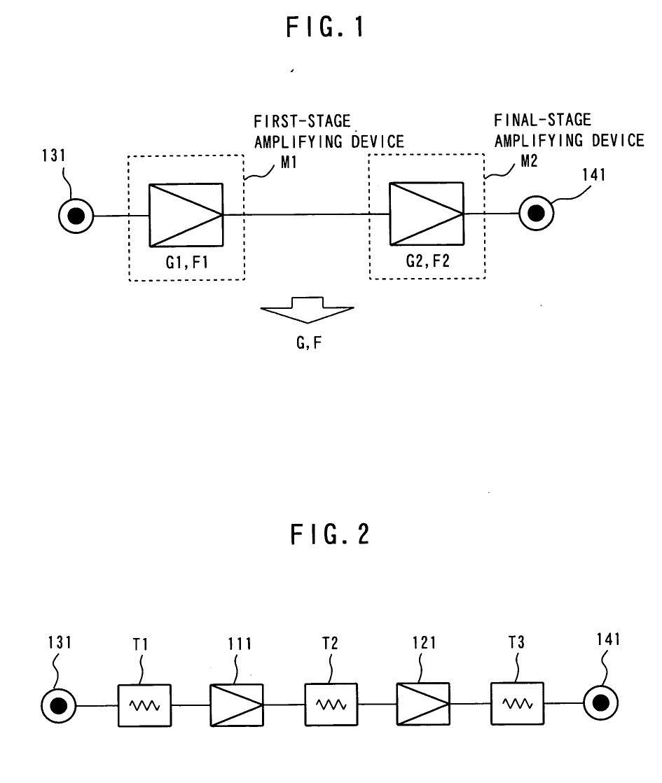

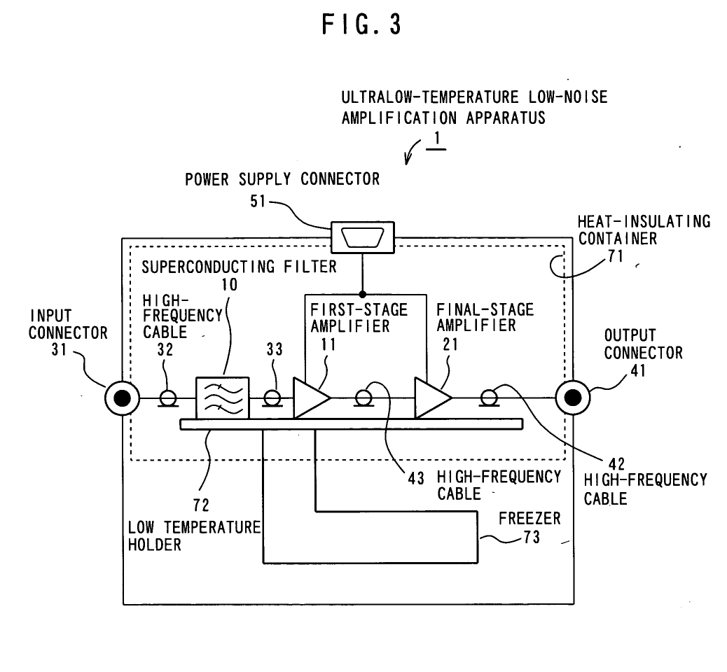

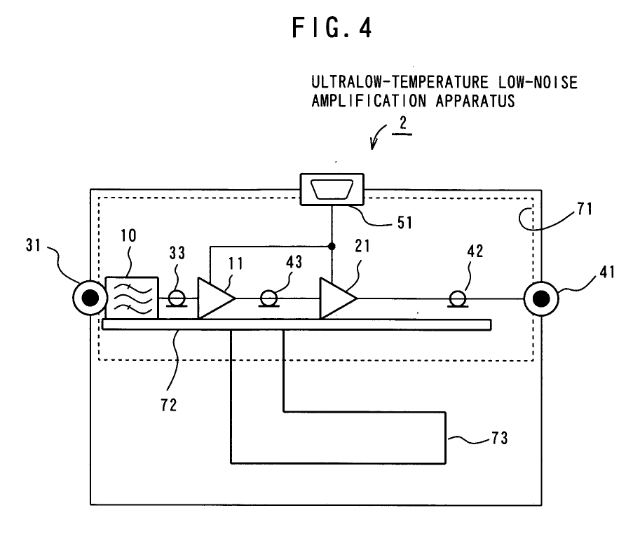

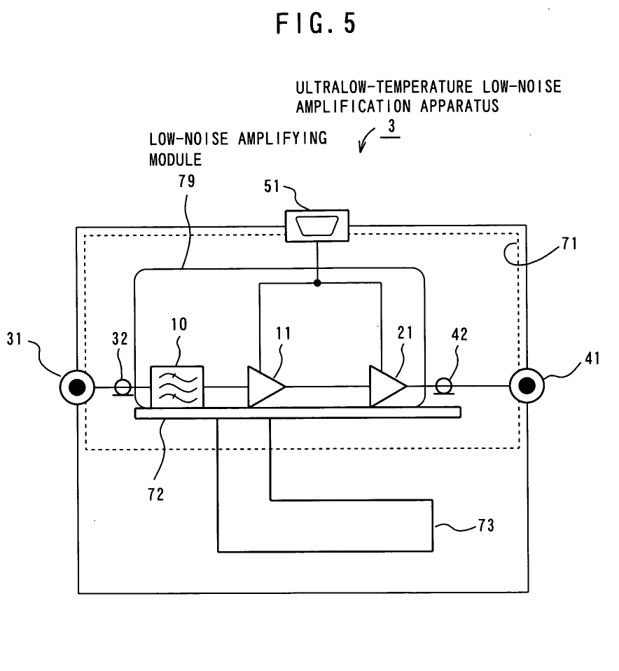

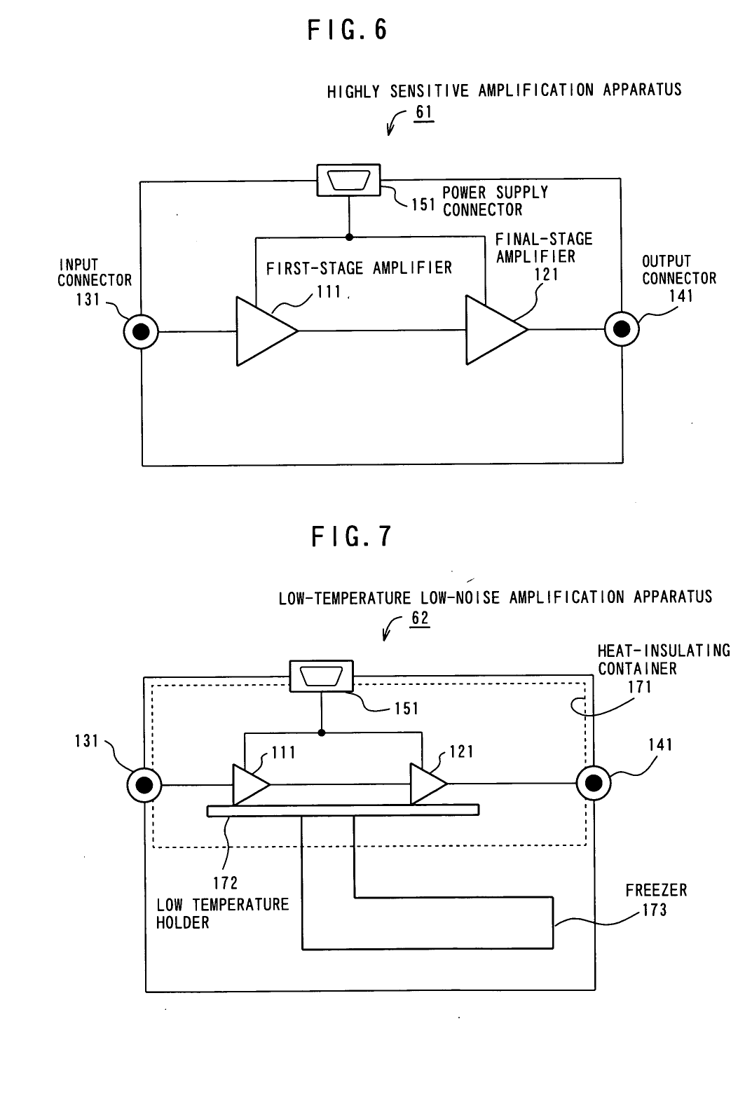

Description will now be made of several modes of embodying this invention with reference to the drawings. FIGS. 1 and 2 are block diagrams for explaining the principle of this invention, FIG. 3 is a block diagram showing a first form of ultralow-temperature low-noise amplification apparatus embodying this invention, FIG. 4 is a block diagram showing a second form of ultralow-temperature low-noise amplification apparatus embodying this invention and FIG. 5 is a block diagram showing a third form of ultralow-temperature low-noise amplification apparatus embodying this invention.

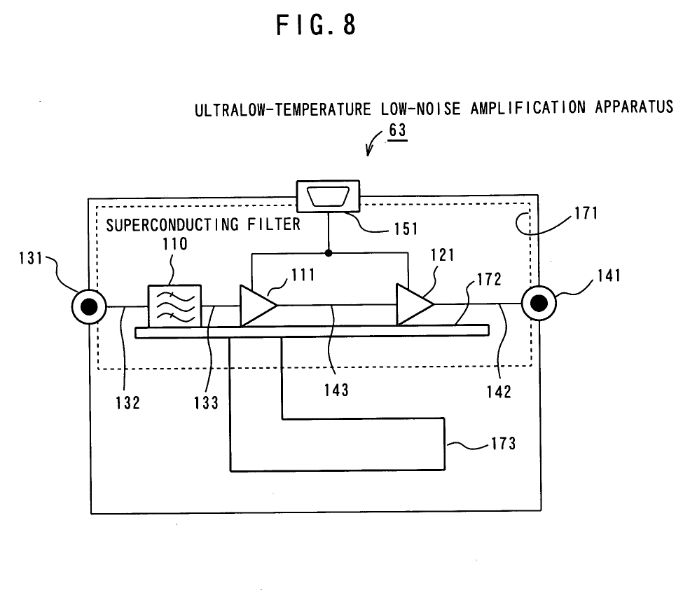

Description will first be made of the principle on which the ultralow-temperature low-noise amplification apparatus of high sensitivity according to this invention is based. Assumed that an ultralow-temperature low-noise amplification apparatus is made with the same layout as the ultralow-temperature low-noise amplification apparatus 63 shown in FIG. 8, and that measures are taken to reduce the amount of heat entering the heat-insulating container 171 and maintain a low noise figure. Let it be assumed that the two-stage amplification apparatus has a first-stage amplifying device M1 having a gain G1 and a noise figure F1 and a final-stage amplifying device M2 having a gain G2 and a noise figure F2 between an input connector 131 and an output connector 141, as shown in FIG. 1. Let it be assumed that the amplification apparatus shown in FIG. 1 has a gain G and a noise figure F as a whole. The noise figure F of the amplification apparatus shown in FIG. 1 is expressed by the following formula (1):
F=F1+(F2−1)/G1 (1)

The formula (1) teaches that it is only the noise figure F1 of the first-stage amplifying device M1 that greatly affects the noise figure F of the two-stage amplification apparatus, while it is hardly affected by the noise figure F2 of the final-stage amplifying device M2. In other words, it can be said that the noise figure of the amplification apparatus as a whole is greatly affected by the noise figure of the first-stage amplifying device, and is less affected by the noise figure of the final-stage amplifying device as the first-stage amplifying device has a higher gain. Accordingly, it is desirable to design the amplifier on the input side with a high gain and a low noise figure and reduce as much as possible any loss caused before the input to the first-stage amplifying device M1, while the noise figure of the final-stage amplifying device M2 on the output side exerts a less effect as there is a higher gain on the input side.

If only the gain, loss and noise figure are taken up in respect of the ultralow-temperature low-noise amplification apparatus 63 shown in FIG. 8 and are expressed as being equivalent, there is obtained a block diagram represented as FIG. 2. An attenuator T1 represents a combination of the high-frequency cable 132, superconducting filter 110 and high-frequency cable 133 shown in FIG. 8 (first signal transmitting device). An attenuator T2 represents the high-frequency cable 143 (second signal transmitting device). An attenuator T3 represents the high-frequency cable 142 (third signal transmitting device). In view of the description of FIG. 1 and the representation of FIG. 2 teaching that it is the loss caused by the attenuator T1 and the noise figure of the first-stage amplifier 111 that exert a large effect directly on the noise figure of the amplification apparatus as a whole, while the superconducting filter 110 causes only a small loss owing to its properties as a superconductor, the apparatus has a very high noise figure if the high-frequency cables 132 and 133 cause a large loss. The characteristics of the apparatus after the first-stage amplifier 111 are considered as exerting a less effect on its noise figure as the first-stage amplifier 111 has a higher gain.

FIG. 3 is a block diagram showing a first form of ultralow-temperature low-noise amplification apparatus as constructed in accordance with the principle described above. In the ultralow-temperature low-noise amplification apparatus 1 shown in FIG. 3, high-frequency signals applied to an input connector 31 pass through a high-frequency cable 32, are filtered through a superconducting filter 10 and are delivered through a high-frequency cable 33 to a first-stage amplifier 11. Cables made of copper, or like material of low resistivity (which causes only a small insertion loss), such as semi-rigid cables, are used as the high-frequency cables 32 and 33. On the input side, it is more important to realize a low noise figure than to avoid the infiltration of heat from outside. In this connection, it is desirable to use cables having as large a cross-sectional area as possible to lower the resistivity of the high-frequency cables 32 and 33 as much as possible.

The high-frequency signals amplified by the first-stage amplifier 11 are delivered to a final-stage amplifier 2 through a high-frequency cable 43 and the high-frequency signals amplified by the final-stage amplifier 21 are sent through a high-frequency cable 42 and outputted through an output connector 41. Referring to the high-frequency cables, a cable formed from molybdenum having a low thermal conductivity is used as the high-frequency cable 42. This makes it possible to prevent any external heat from entering through the output connector 41. The high-frequency cable 43 may be a cable of any adequate material, but is preferably of a material of low resistivity. A low temperature holder 72 is cooled by a freezer 73, while it is positioned in contact with the superconducting filter 10 and the amplifiers 11 and 21.

A heat-insulating container 71 carrying the input and output connectors 31 and 41 and a power supply connector 51 on its sidewalls, etc. and minimizing the infiltration of any external heat encloses the high-frequency cables 32, 33, 43 and 42, the superconducting filter 10 and the amplifiers 11 and 21 tightly and shuts off the infiltration of any external heat. The heat-insulating container 71 has its interior kept vacuum by an evacuator not shown. Accordingly, the interior of the heat-insulating container 71 including the low temperature holder 72 cooled by the freezer 73 is steadily kept at a low temperature. The following is a comparison of characteristics between copper and molybdenum mentioned above as the materials for the high-frequency cables 32 and 33 and the high-frequency cable 42, respectively:

### Thermal Conductivity Electrical Resistivity

(1) Copper 403 κ/(W·m⁻¹·K⁻¹) 1.55 ρ/(Ω.m)
(2) Molybdenum 139 κ/(W·m⁻¹·K⁻¹) 5.00 ρ/(Ω.m)
   from which it is obvious that the selection of the materials for the high-frequency cables is proper as intended, since copper used for the cables on the input side is low in electrical resistivity, while molybdenum for the output side is low in thermal conductivity.

FIG. 4 is a block diagram showing a second form of ultralow-temperature low-noise amplification apparatus embodying this invention. The ultralow-temperature low-noise amplification apparatus 2 is substantially of the same construction as the ultralow-temperature low-noise amplification apparatus 1 shown in FIG. 3, and differs therefrom only in that high-frequency signals applied to the input connector 31 are so arranged as to be delivered to the superconducting filter 10 directly without passing through any high-frequency cable 32. The direct connection of the input connector 31 and the superconducting filter 10 makes it possible to reduce any loss otherwise caused by the high-frequency cable 32 and thereby improve the noise figure of the ultralow-temperature low-noise amplification apparatus as a whole.

FIG. 5 is a block diagram showing a third form of ultralow-temperature low-noise amplification apparatus embodying this invention. The ultralow-temperature low-noise amplification apparatus 3 is substantially of the same construction as the ultralow-temperature low-noise amplification apparatus 1 shown in FIG. 3, and differs therefrom only in that the superconducting filter 10 and the amplifiers 11 and 21 are combined to constitute a low-noise amplifying module 79. The combination of the superconducting filter 10 and the amplifiers 11 and 21 into the low-noise amplifying module 79 makes unnecessary the high-frequency cables 33 and 43 used in the apparatus of FIG. 3 and permits a corresponding reduction in any insertion loss. Micro-strip lines can, for example, be used to provide connections making up for the high-frequency cables 33 and 43. A high-temperature superconductor is preferably used as the material for those connections.

Although attention has been drawn only to the materials for the high-frequency cables in the foregoing description, it is possible to employ a device allowing for electrical connection, while cutting off any physical connection (a coupling condenser), since the signals to be processed are of an alternating current. It is also possible to use a long high-frequency cable on the output side of the apparatus. The same is applicable to any amplification apparatus not having any superconducting filter, though the foregoing description has been only of examples of apparatus having a superconducting filter. Moreover, it is needless to say that while those examples have all been of apparatus having two amplifiers, the same principle is applicable to any apparatus having more than two amplifiers.

1. An ultralow-temperature low-noise amplification apparatus having a first-stage amplifier and a final-stage amplifier which are cooled to a very low temperature between an input connector and an output connector, comprising:
an input connecting device connecting the input connector and the first-stage amplifier and so arranged as to reduce any insertion loss; and
an output connecting device connecting the final-stage amplifier and the output connector and so arranged as to reduce the conduction of heat.

2. An ultralow-temperature low-noise amplification apparatus comprising:
a first signal transmitting device connecting an input connector and a receive filter;
a second signal transmitting device connecting the receive filter and a first-stage amplifier;
a third signal transmitting device connecting the first-stage amplifier and a final-stage amplifier;
a fourth signal transmitting device connecting the final-stage amplifier and an output connector;
a cooling holder for cooling the receive filter, second signal transmitting device, first-stage amplifier, third signal transmitting device and final-stage amplifier to a very low temperature and holding them at that temperature; and
a heat-insulating container carrying the input and output connectors and a power supply connector on its outer wall and enclosing the second signal transmitting device, first-stage amplifier, third signal transmitting device, final-stage amplifier and cooling holder tightly in a vacuum state.

3. The apparatus according to claim 2, wherein the first signal transmitting device is constituted by a material of low resistivity.

4. The apparatus according to claim 2, wherein the receive filter, second and third signal transmitting devices, and final-stage amplifier constitute a single module.

5. An ultralow-temperature low-noise amplification apparatus comprising:
a receive filter connected to an input connector;
a first signal transmitting device connecting the receive filter and a first-stage amplifier;
a second signal transmitting device connecting the first-stage amplifier and a final-stage amplifier;
a third signal transmitting device connecting the final-stage amplifier and an output connector;
a cooling holder for cooling the receive filter, first signal transmitting device, first-stage amplifier, second signal transmitting device and final-stage amplifier to a very low temperature and holding them at that temperature; and
a heat-insulating container carrying the input and output connectors and a power supply connector on its outer wall and enclosing the receive filter, first signal transmitting device, first-stage amplifier, second signal transmitting device, final-stage amplifier and cooling holder tightly in a vacuum state.

6. The apparatus according to claim 5, wherein the receive filter, first and second signal transmitting devices, and final-stage amplifier constitute a single module.
